(19) United States
(12) Patent Application Publication
(10) Pub. No.: US 2010/0110696 A1
(43) Pub. Date: May 6, 2010

(54) ICICLE ATTACHMENT

(76) Inventor: CRAIG R. BOCKMAN, Los Angeles, CA (US)

Correspondence Address: WALTER A. HACKLER, Ph,D.;PATENT LAW OFFICE, SUITE B, 2372 S.E. BRISTOL STREET, NEWPORT BEACH, CA, 92260-0755, US

(21) Appl. No.: 12/264,431

(22) Filed: Nov. 4, 2008

(51) Int. Cl. F21V 17/00

(52) U.S. Cl. 362/353

(57) ABSTRACT

An icicle attachment for a light bulb which includes a hollow tube having a shape simulating a pendant spear of ice. The tube is tapered and receives a standard string light bulb with two radially inwardly directed spokes for enabling a bulb socket to be inserted therepast and thereafter retain the bulb socket in the tube top. Slits formed in the walls of the tube proximate the open body and communicating therewith enhance water drainage from the tube and light escape or sparkle of the icicle attachment.

The present invention is generally related to decorative lamp casings and lamp bulb envelopes and is more particularly directed to an icicle attachment for a light bulb.

Existing decorative lamp covers have the general appearance of an icicle, however these devices do not present the visual effect of a real icicle and further do not provide light escape or sparkle provided by actual icicles.

In addition, prior art devices do not provide for enhancing water drainage or dripping realistically found in natural light bulbs.

The present invention fills that need.

### SUMMARY OF THE INVENTION

An icicle attachment in accordance with the present invention for a light bulb generally includes a hollow tube having a shape simulating a pendant spear of ice with the tube being tapered with a wide top opening for receiving a standard string holiday light bulb and an opposing narrow open bottom. The tube is formed from a translucent heat resistant diffusing white plastic in order to emulate a lighted icicle.

At least two radially inward directed spokes are disposed at the tube top with the spokes being pliable for enabling a bulb socket to be inserted therepast into the tube top and thereafter retained the bulb socket in the tube top. Alternatively, a clamshell arrangement may be provided for ease of attaching to the lights with the spokes holding the bulb socket in place.

Notches formed in a rim or the tube top enable straight passage of socket wire through the tube top and flush mounting of the tube top against the decorated surface. This further enhances the realistic effect of the icicle attachment in accordance with the present invention by simulating direct attachment to an eave or the like, and in addition to flush mounting, it allows for the light socket to be hidden.

Slits formed in walls of the tube proximate the open body and communicating therewith enhance drainage of the tube and light escape or sparkle and further provide a dripping action when water accumulated during precipitation drains from the icicle attachment.

Preferably, the tube has greater opacity at the tube top than the tube bottom to simulate an icicle appearance and to diffuse the light along the tube and the tube has an undulating surface between the tube top and the tube top bottom for varying a direction of emitted light as adding to the sparkle of the icicle attachment in accordance with the present invention. The undulations are also designed to mimic the unevenness of a real icicle.

### BRIEF DESCRIPTION OF THE DRAWINGS

The advantages and features of the present invention will be better understood by the following description when considered in conjunction with the accompanying drawings in which:

FIG. 1 is a cross sectional view of an icicle attachment in accordance with the present invention generally showing a hollow tube, a light bulb, socket, and notches formed in the walls of the tube proximate an open end for enabling straight passage of a socket wire;

FIG. 2 is a top view of the icicle attachment illustrating more clearly inwardly directed spokes for enabling a bulb socket to be inserted therepast into the tube top and thereafter retain the bulb socket in the tube top; and

FIG. 3 is an elevation view of the icicle attachment shown in FIG. 1 more clearly showing the notches along with a slit formed in the tube of the wall proximate an open bottom and communicating therewith for enhancing drainage from the tube and light escape or sparkle from the tube.

### DETAILED DESCRIPTION

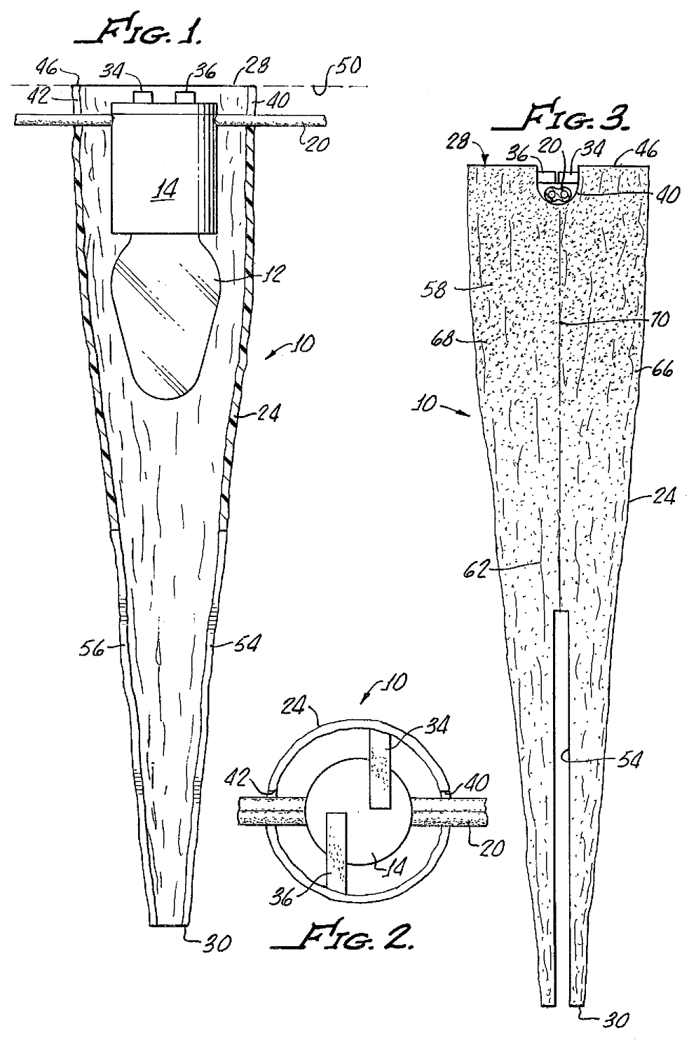

With reference to FIGS. 1-3 there is shown an icicle attachment 10 for a light bulb 12 and socket 14 in communication with companion sockets/bulbs (not shown) by socket wire 20.

The icicle attachment 10 includes a hollow tube 24 having a wide open top 28 for receiving the light bulb 12 and socket 14 and an opposing narrow open bottom 30 on a with the tube 24 being formed from a translucent, heat resistant diffusing white plastic of any suitable configuration for emulating a lighted icicle.

As shown in FIGS. 1 and 3, but best shown in FIG. 2, at least two radially inwardly directed spokes 34, 36 which has sufficient flexibility, or pliability, for enabling the light bulb 12 and socket 14 to be inserted therepast into the tube top 28 and thereafter retain the bulb socket 14 in the tube top 28 through tension in the wire 20.

Notches 40, 42 formed in a rim 46 enable straight passage of the socket wire 20 through the tube top 28 which enables flush mounting of the tube top 28 against a decorated surface 50, such as an eve. This simulates the direct attachment of the icicle attachment to the eve to create a more realistic icicle appearance. In addition, the present invention 10 provides for a ease of attachment to a house, for ease of changing the design with different separation between “icicles” and different numbers of icicles showing, variations in color (color lights vs. white vs. clear), variations in size easily changed, and provides for mixing icicles in with the lights. These features can only be accomplished easily with the use of this design that allows it to be placed over existing lights.

Slits 54, 56 formed in the tube 24 approximate the open bottom 30 and communicating therewith not only enhance drainage of accumulated water but also provide a light escape with simulates a sparkle of the icicle attachment 10.

With reference to FIG. 3, there is shown, by way of dappling 58, the tube 24 having greater opacity at or near the tube top 28 than the tube bottom 30. In addition, the tube 24 may have an undulating surface 62 for varying a direction of emitted light and further enhancing the overall lighted effect of the icicle attachment 10 in simulating an actual icicle.

In addition, the icicle attachment 10 in accordance with the present invention may include two halves 66, 68 as indicated by dashed line 70, which in effect provide a clam shell arrangement for enabling assembly of the attachment 10, around the bulb 12 and socket 14.

Although there has been hereinabove described a specific icicle attachment in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. An icicle attachment for a light bulb, said icicle attachment comprising:
a hollow tube having a shape simulating a pendant spear of ice, the tube being tapered with a wide top open for receiving a standard stringed holiday light bulb and an opposing narrow open bottom, the tube being formed from a translucent, heat resistant, diffusing white plastic in order to emulate a lighted icicle; and
at least two radial inwardly directed spokes disposed at the tube top, the spokes being pliable for enabling a bulb socket to be inserted therepast into the tube top and thereafter retain said bulb socket in the tube top.

2. The icicle attachment according to claim 1 further comprising notches formed in a rim of the tube top for enabling straight passage of socket wire through the tube top and flush mounting of the tube top against a decorated surface.

3. The icicle attachment according to claim 2 further comprising slits formed in walls of the tube proximate the open bottom and communicating therewith for enhancing drainage from the tube and light escape or sparkle.

4. The icicle attachment according to claim 3 wherein the tube has greater opacity at the tube top than the tube bottom.

5. The icicle attachment according to claim 4 wherein the tube has an undulating surface between the tube top and the tube bottom for varying a direction of emitted light.

6. An icicle attachment for a light bulb, said icicle attachment comprising:
a hollow tube having a shape simulating a pendant spear of ice, the tube being tapered with a wide top open for receiving a standard stringed holiday light bulb and an opposing narrow open bottom, the tube being formed from a translucent, heat resistant, diffusing white plastic in order to emulate a lighted icicle, said hollow tube being formed from two clam shelled halves; and
at least two radial inwardly directed spokes disposed at the tube top, for retaining said bulb socket in the tube top.

7. The icicle attachment according to claim 6 further comprising notches formed in a rim of the tube top for enabling straight passage of socket wire through the tube top and flush mounting of the tube top against a decorated surface.

8. The icicle attachment according to claim 7 further comprising slits formed in walls of the tube proximate the open bottom and communicating therewith for enhancing drainage from the tube and light escape or sparkle.

9. The icicle attachment according to claim 8 wherein the tube has greater opacity at the tube top than the tube bottom.

10. The icicle attachment according to claim 9 wherein the tube has an undulating surface between the tube top and the tube bottom for varying a direction of emitted light.
